(19) United States
(12) Patent Application Publication
(10) Pub. No.: US 2006/0066656 A1
(43) Pub. Date: Mar. 30, 2006

(54) Method for reducing dot placement errors in imaging apparatus

(76) Inventor: Colin Geoffrey Maher, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/951,495

(22) Filed: Sep. 28, 2004

(51) Int. Cl. B41J 29/38

(52) U.S. Cl. 347/19

(57) ABSTRACT

A method for reducing dot placement errors in an imaging apparatus includes printing with a printhead having a plurality of nozzles a plurality of printhead alignment patterns, each printhead alignment pattern being printed at a different predefined printhead firing frequency of a plurality of printhead firing frequencies; and determining a set of printhead specific compensation values for each of the plurality of printhead firing frequencies for use in printhead alignment.

### BACKGROUND OF THE INVENTION

1. Field of the Invention

The present invention relates to an imaging apparatus, and, more particularly, to a method for reducing dot placement errors in an imaging apparatus.

2. Description of the Related Art

An imaging apparatus, in the form of an ink jet printer, forms an image on a print medium by ejecting ink from a plurality of ink jetting nozzles of an ink jet printhead to form a pattern of ink dots on the print medium. Such an ink jet printer typically includes a reciprocating printhead carrier that transports one or more ink jet printheads across the print medium along a bi-directional scanning path defining a print zone of the printer. When printing with multiple color printheads, color and mono printheads, or color and photo printheads, the printheads must be aligned in both the scan and media feed directions for optimal print quality. Printhead alignment may be performed by printing an alignment pattern, measuring dot placement errors of the pattern, and then generating alignment values to correct for the dot placement errors.

Market pressure continues to force ink jet printers to print faster with better print quality. One way to print faster is to increase the frequency at which any given ink jetting nozzle can fire, i.e., jet, ink. The rate at which an ink jetting nozzle can fire successive ink drops from the nozzle is often referred to as the firing frequency of the nozzle. For example, firing frequencies up to 24 kHz are common today in print modes where high speed is required. However, in achieving high print quality it is common to print in multi-pass shingling modes of up to 16 passes. In such high quality modes, the exact frequency at which any given nozzle may print varies greatly depending on what is being printed. However, most nozzles will generally print at frequencies no greater than 2 kHz most of the time. Thus, the printhead is forced to jet drops precisely under a wide range of frequencies, depending at least in part on the print mode in which the printing is to take place.

The firing frequency of a nozzle greatly affects the velocity of the ink drops jetted from the nozzle. As the time between consecutive fires of a nozzle approaches the refill time, the drop velocity decreases. Also, drop velocity is related to dot position on the paper. Accordingly, if printhead alignment is performed at a particular frequency, such as that associated with printing a solid block with repeated firings of the nozzles, then the alignment values used to correct for the dot placement errors at that frequency may not adequately compensate for dot placement errors when printing at a different firing frequency, particularly if the different firing frequency is significantly different from that of the firing frequency used during printhead alignment.

To solve this problem in the past, a static alignment offset was introduced for certain print modes, such as high quality print modes. However, such an approach may not adequately account for variations in printhead firing characteristics, even within the same printhead design specification. The method also may assume a nominal paper gap and a nominal constant carrier velocity, but which in practice is often not the case.

What is needed in the art is an improved method for reducing dot placement errors in an imaging apparatus.

### SUMMARY OF THE INVENTION

The present invention provides a method for reducing dot placement errors in an imaging apparatus.

The present invention, in one form thereof, relates to a method for reducing dot placement errors in an imaging apparatus, including printing with a printhead having a plurality of nozzles a plurality of printhead alignment patterns, each printhead alignment pattern being printed at a different predefined printhead firing frequency of a plurality of printhead firing frequencies; and determining a set of printhead specific compensation values for each of the plurality of printhead firing frequencies for use in printhead alignment.

The present invention, in another form thereof, relates to a method for reducing dot placement errors in an imaging apparatus, including providing a set of printhead specific compensation values for a printhead having a plurality of nozzles, each printhead specific compensation value in the set being associated with a respective printhead firing frequency of a plurality of printhead firing frequencies; and selecting a printhead specific compensation value from the set of printhead specific compensation values corresponding to a firing frequency associated with printing an image with the imaging apparatus to effect printhead alignment at the firing frequency associated with printing the image.

An advantage of the present invention is that it reduces dot placement errors by accounting for variations in dot placement errors due to printing at various firing frequencies.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 shows an exemplary configuration of a printhead, and the projection of the printhead over a print medium sheet.

FIG. 3 is a flowchart depicting a general method for reducing dot placement errors in accordance with the present invention.

FIGS. 4-7 show exemplary fill patterns for printing a printhead alignment pattern in accordance with the present invention.

FIG. 8 is a graph that illustrates an exemplary relationship between ink drop velocity and the firing frequency for the nozzles of a printhead.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

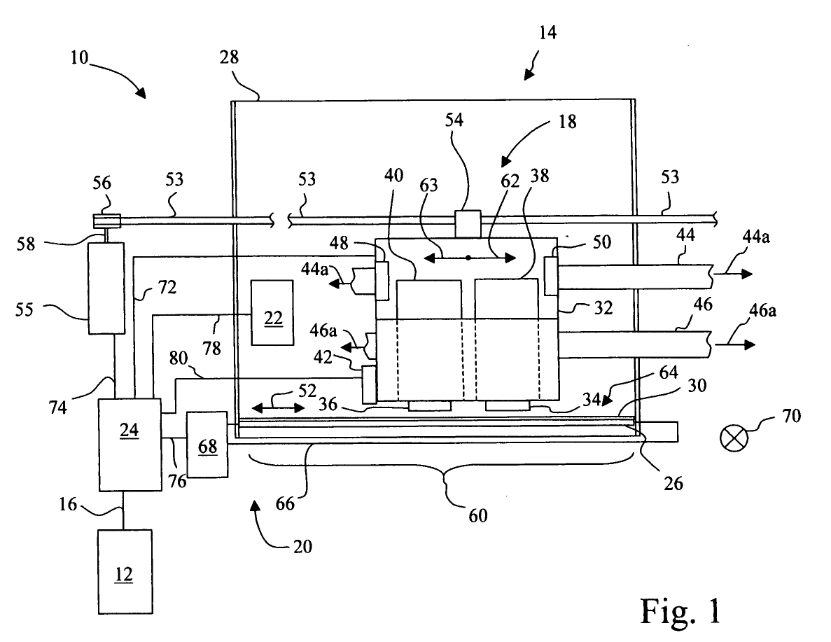

Referring now to the drawings, and particularly to FIG. 1, there is shown an imaging system 10 embodying the present invention. Imaging system 10 may include a host 12, or alternatively, imaging system 10 may be a standalone system.

Imaging system 10 includes an imaging apparatus 14, which may be in the form of an ink jet printer, as shown. Thus, for example, imaging apparatus 14 may be a conventional ink jet printer, or may form the print engine for a multi-function apparatus, such as for example, a standalone unit that has faxing and copying capability, in addition to printing.

Host 12, which may be optional, may be communicatively coupled to imaging apparatus 14 via a communications link 16. As used herein, the term “communications link” is used to generally refer to structure that facilitates electronic communication between two components, and may operate using wired or wireless technology. Communications link 16 may be, for example, a direct electrical connection, a wireless connection, or a network connection.

In embodiments including host 12, host 12 may be, for example, a personal computer including a display device, an input device (e.g., keyboard), a processor, input/output (I/O) interfaces, memory, such as RAM, ROM, NVRAM, and a mass data storage device, such as a hard drive, CD-ROM and/or DVD units. During operation, host 12 includes in its memory a software program including program instructions that function as a printer driver for imaging apparatus 14. The printer driver is in communication with imaging apparatus 14 via communications link 16. The printer driver, for example, includes a halftoning unit and a data formatter that places print data and print commands in a format that can be recognized by imaging apparatus 14. In a network environment, communications between host 12 and imaging apparatus 14 may be facilitated via a standard communication protocol, such as the Network Printer Alliance Protocol (NPAP).

In the embodiment of FIG. 1, imaging apparatus 14, in the form of an ink jet printer, includes a printhead carrier system 18, a feed roller unit 20, a sheet picking unit 22, a controller 24, a mid-frame 26 and a media source 28.

Media source 28 is configured to receive a plurality of print medium sheets from which a print medium, i.e., an individual print medium sheet 30, is picked by sheet picking unit 22 and transported to feed roller unit 20, which in turn further transports print medium sheet 30 during an imaging operation. Print medium sheet 30 may be, for example, plain paper, coated paper, photo paper or transparency media.

Printhead carrier system 18 includes a printhead carrier 32 for mounting and carrying a color printhead 34 and/or a monochrome printhead 36. A color ink reservoir 38 is provided in fluid communication with color printhead 34, and a monochrome ink reservoir 40 is provided in fluid communication with monochrome printhead 36. Those skilled in the art will recognize that color printhead 34 and color ink reservoir 38 may be formed as individual discrete units, or may be combined as an integral unitary printhead cartridge. Likewise, monochrome printhead 36 and monochrome ink reservoir 40 may be formed as individual discrete units, or may be combined as an integral unitary printhead cartridge.

Printhead carrier system 18 further includes a reflectance sensor 42 attached to printhead carrier 32. Reflectance sensor 42 may be used, for example, during scanning of a printhead alignment pattern. Reflectance sensor 42 may be, for example, a unitary optical sensor including a light source, such as a light emitting diode (LED), and a reflectance detector, such as a phototransistor. The reflectance detector is located on the same side of a media as the light source. The operation of such sensors is well known in the art, and thus, will be discussed herein to the extent necessary to relate the operation of reflectance sensor 42 to the operation of the present invention. For example, the LED of reflectance sensor 42 directs light at a predefined angle onto a reference surface, such as the surface of print medium sheet 30, and at least a portion of light reflected from the surface is received by the reflectance detector of reflectance sensor 42. The intensity of the reflected light received by the reflectance detector varies with the density of a printed image present on print medium sheet 30. The light received by the reflectance detector of reflectance sensor 42 is converted to an electrical signal by the reflectance detector of reflectance sensor 42. The signal generated by the reflectance detector corresponds to the reflectivity from print medium sheet 30, and the reflectivity of the printhead alignment pattern, scanned by reflectance sensor 42.

Printhead carrier 32 is guided by a pair of guide members 44, 46, which may be, for example, in the form of guide rods. Each of guide members 44, 46 includes a respective horizontal axis 44a, 46a. Printhead carrier 32 includes a pair of guide member bearings 48, 50, each of guide member bearings 48, 50 including a respective aperture for receiving guide member 44. The horizontal axis 44a of guide member 44 generally defines a bi-directional scan path 52, also referred to as main scan direction 52, for printhead carrier 32. Accordingly, bi-directional scan path 52 is associated with each of printheads 34, 36 and reflectance sensor 42.

Printhead carrier 32 is connected to a carrier transport belt 53 via a carrier drive attachment device 54. Carrier transport belt 53 is driven by a carrier motor 55 via a carrier pulley 56. Carrier motor 55 has a rotating carrier motor shaft 58 that is attached to carrier pulley 56. Carrier motor 55 can be, for example, a direct current (DC) motor or a stepper motor. At the directive of controller 24, printhead carrier 32 is transported in a reciprocating manner along guide members 44, 46, and in turn, along main scan direction 52.

The reciprocation of printhead carrier 32 transports ink jet printheads 34, 36 and reflectance sensor 42 across the print medium sheet 30, such as paper, along main scan direction 52 to define a print/sense zone 60 of imaging apparatus 14. The reciprocation of printhead carrier 32 occurs in the main scan direction bi-directionally, and is also commonly referred to as the horizontal direction, including a left-to-right carrier scan direction 62 and a right-to-left carrier scan direction 63. Generally, during each scan of printhead carrier 32 while printing or sensing, the print medium sheet 30 is held stationary by feed roller unit 20.

Mid-frame 26 provides support for the print medium sheet 30 when the print medium sheet 30 is in print/sense zone 60, and in part, defines a portion of a print medium path 64 of imaging apparatus 14.

Feed roller unit 20 includes a feed roller 66 and corresponding index pinch rollers (not shown). Feed roller 66 is driven by a drive unit 68. The index pinch rollers apply a biasing force to hold the print medium sheet 30 in contact with respective driven feed roller 66. Drive unit 68 includes a drive source, such as a stepper motor, and an associated drive mechanism, such as a gear train or belt/pulley arrangement. Feed roller unit 20 feeds the print medium sheet 30 in a sheet feed direction 70, designated as an X in a circle to indicate that the sheet feed direction is out of the plane of FIG. 1 toward the reader. The sheet feed direction 70 is commonly referred to as the vertical direction, which is perpendicular to the horizontal bi-directional scan path 52, and in turn, is perpendicular to the horizontal carrier scan directions 62, 63. Thus, with respect to print medium sheet 30, carrier reciprocation occurs in a horizontal direction and media advance occurs in a vertical direction, and the carrier reciprocation is generally perpendicular to the media advance.

Controller 24 includes a microprocessor having an associated random access memory (RAM) and read only memory (ROM). Controller 24 is electrically connected and communicatively coupled to printheads 34, 36 via a communications link 72, such as for example a printhead interface cable. Controller 24 is electrically connected and communicatively coupled to carrier motor 55 via a communications link 74, such as for example an interface cable. Controller 24 is electrically connected and communicatively coupled to drive unit 68 via a communications link 76, such as for example an interface cable. Controller 24 is electrically connected and communicatively coupled to sheet picking unit 22 via a communications link 78, such as for example an interface cable. Controller 24 is electrically connected and communicatively coupled to reflectance sensor 42 via a communications link 80, such as for example an interface cable.

Controller 24 executes program instructions to effect the printing of an image on the print medium sheet 30, such as for example, by selecting the index feed distance of print medium sheet 30 along print medium path 64 as conveyed by feed roller 66, controlling the acceleration rate and velocity of printhead carrier 32, and controlling the operations of printheads 34, 36, such as for example, by controlling the firing frequency of individual nozzles of printhead 34 and/or printhead 36. As used herein, the term “firing frequency” refers to the frequency of successive firings of a nozzle of a printhead in forming adjacent dots on the same scan line of an image. In addition, controller 24 executes instructions to print printhead alignment patterns and to determine compensation values based on a reading of the printhead alignment patterns for reducing dot placement errors when printing, such as bidirectional printing, with one or both of printheads 34, 36 in imaging apparatus 14.

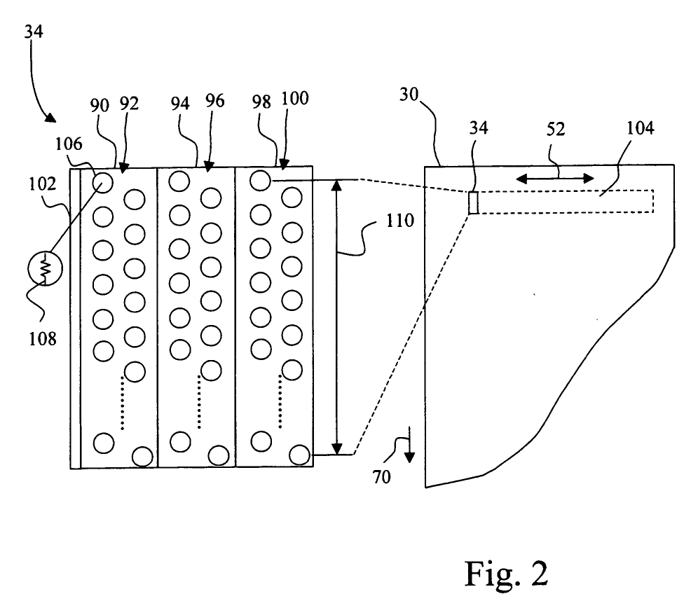

FIG. 2 shows one exemplary configuration of printhead 34, which includes a cyan nozzle plate 90 including a cyan nozzle array 92, a yellow nozzle plate 94 including a yellow nozzle array 96, and a magenta nozzle plate 98 including a magenta nozzle array 100, for respectively ejecting cyan (C) ink, yellow (Y) ink, and magenta (M) ink. In addition, printhead 34 may include a memory 102 for storing information relating to printhead 34 and/or imaging apparatus 14. For example, memory 102 may be formed integral with printhead 34, or may be attached to color ink reservoir 38. For convenience, and ease of discussion, memory 102 may also sometimes be referred to as printhead memory 102.

As further illustrated in FIG. 2, printhead carrier 32 is controlled by controller 24 to move printhead 34 in a reciprocating manner in main scan direction 52, with each left-to-right movement in direction 62, or right-to-left movement in direction 63, of printhead carrier 32 along main scan direction 52 over print medium sheet 30 being referred to herein as a pass. The area traced by printhead 34 over print medium sheet 30 for a given pass will be referred to herein as a printing swath, such as for example, swath 104 as shown in FIG. 2.

In the exemplary nozzle configuration for ink jet printhead 34 shown in FIG. 2, each of nozzle arrays 92, 96 and 100 include a plurality of ink jetting nozzles 106, with each ink jetting nozzle 106 having at least one corresponding heating element 108. The plurality of ink jetting nozzles 106 may include nozzles of a plurality of sizes, such as for example, nozzles having a large nozzle opening and nozzles having a small nozzle opening. A swath height 110 of swath 104 corresponds to the distance between the uppermost and lowermost of the nozzles within an array of nozzles of printhead 34. In this example, the swath height 110 may be the same for each of nozzle arrays 92, 96 and 100; however, this need not be the case, i.e., it is possible that the swath heights of nozzle arrays 92, 96 and 100 may be different, either by design or due to manufacturing tolerances.

In considering ink jet printhead 34, for example, printhead alignment may be performed as between the nozzle arrays 92, 96 and 100 due to differences in their respective drop velocities in relation to changes in firing frequency. Also, within a particular array, printhead alignment may be desired as between the large nozzles and the small nozzles due to differences in their respective drop velocities in relation to changes in firing frequency.

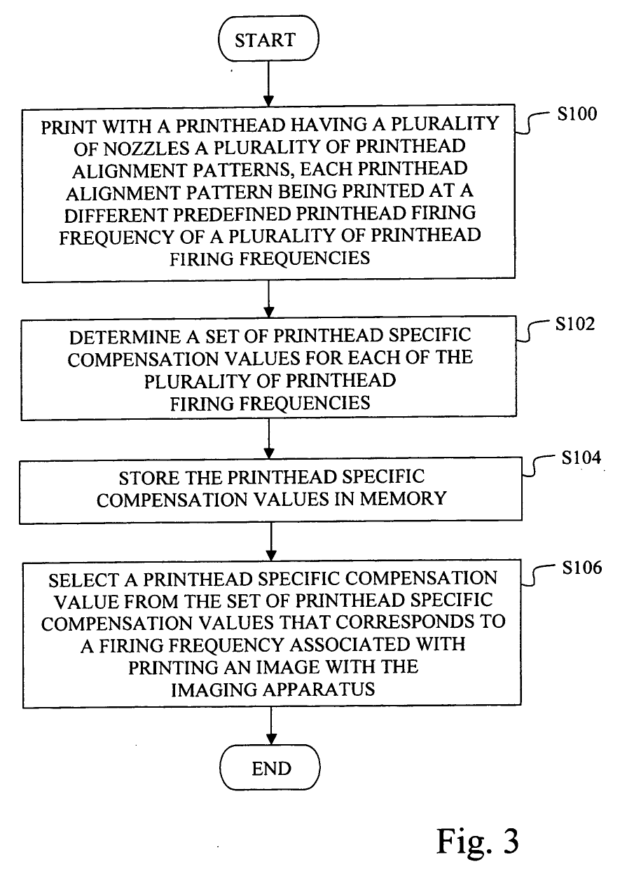

FIG. 3 is a flowchart depicting a general method for reducing dot placement errors in an imaging apparatus, in accordance with the present invention. The operation of the invention will be further described with respect to FIGS. 1, 2, and 4-8.

At step S100, a plurality of printhead alignment patterns is printed with a printhead, such as with nozzle array 92 of printhead 34. Each printhead alignment pattern is printed at a different predefined printhead firing frequency of a plurality of printhead firing frequencies.

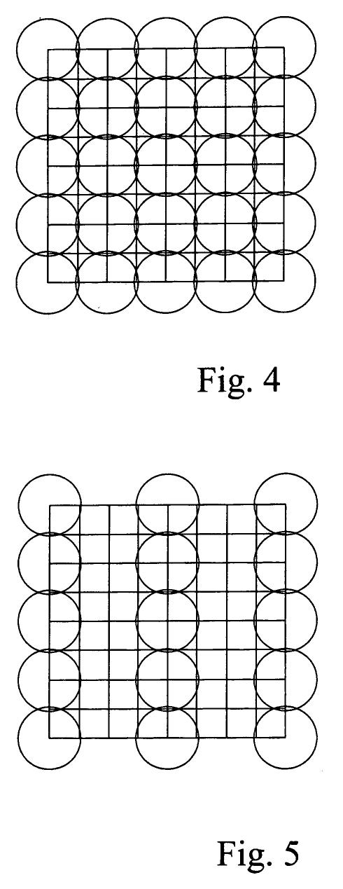

Exemplary patterns are shown in FIGS. 4-7. Each different predefined printhead firing frequency used in printing each of the plurality of printhead alignment patterns may be achieved, for example, by changing a horizontal printing resolution for each of the plurality of printhead alignment patterns while maintaining a constant carrier velocity.

FIG. 4 shows a full fill 600 dots per inch (dpi) pattern on a 1200 dpi grid. This full fill pattern may be printed, for example, at a firing frequency of 24 kHz with a carrier velocity of 40 inches per second (ips). This pattern may represent, for example, the baseline firing frequency for printhead 34, and may be the maximum available firing frequency from printhead 34.

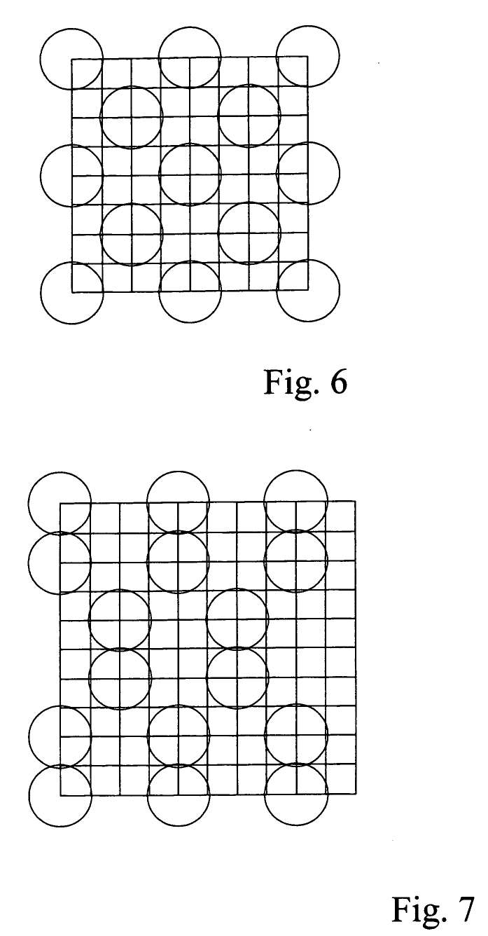

FIG. 5 shows a one-on, one-off pattern having half the spatial frequency as the pattern of FIG. 4. Assuming again a carrier velocity of 40 ips, then the firing frequency will be half of that of FIG. 4, i.e., 12 kHz. FIG. 6 shows another exemplary one-on, one-off pattern, which is in the form of a checkerboard pattern. FIG. 7 shows still another exemplary one-on, one-off pattern (horizontal). In view of the above, those skilled in the art will recognize that other patterns may be used to achieve a pattern printed at one-half the baseline firing frequency.

Likewise, a one-on, two-off pattern (not shown) will have one-third the spatial frequency as the pattern of FIG. 4, and again assuming a carrier velocity of 40 ips, then the firing frequency will be one-third of that of FIG. 4, i.e., 8 kHz. As a further example, a one-on, three-off pattern will have one-fourth the spatial frequency as the pattern of FIG. 4, and again assuming a carrier velocity of 40 ips, then the firing frequency will be one-fourth of that of FIG. 4, i.e., 6 kHz.

Alternatively, each different predefined printhead firing frequency used in printing each of the plurality of printhead alignment patterns may be achieved by changing a carrier velocity for each of the plurality of printhead alignment patterns and accordingly adjusting a firing rate of the printhead, or by maintaining a constant firing rate. This approach has the advantage of printing each of the plurality of printhead alignment patterns as a full fill pattern.

As a further alternative, such a full fill pattern may be achieved using multiple passes in a shingling fashion when printing the plurality of printhead alignment patterns.

At step S102 of FIG. 3, a set of printhead specific compensation values is determined for each of the plurality of printhead firing frequencies. The compensation values may represent, for example, an offset in one of directions 62, 63 of main scan direction 52 to bring printhead 34 in alignment during bi-directional printing at a particular firing frequency. A corresponding set of printhead specific compensation values may be determined for each nozzle array of printhead 34, e.g., one set for cyan nozzle array 92, one set for yellow nozzle array 96 and one set for magenta nozzle array 100. Also, it is possible that such printhead specific compensation values may be associated with different colors of ink, or different ink types, such as dye based inks and pigment based inks.

The reason for determining the set of printhead specific compensation values for each of the plurality of printhead firing frequencies, as well as printing each printhead alignment pattern at a different predefined printhead firing frequency, may be best explained in the examples that follows.

As a first example, consider that each printing mode of a plurality of printing modes available in imaging apparatus 14 may have associated therewith a particular firing frequency. As another example, consider that each printing swath during the printing of an image may have associated therewith a particular firing frequency. As still another example, consider that each printhead nozzle may have associated therewith a particular firing frequency depending on the image data to be printed. In each case, there is a variation in firing frequency for printhead 34 depending upon the printing scenario and, as stated above, the firing frequency of a nozzle greatly affects the velocity of the drops jetted from the nozzle, and thus the dot placement accuracy may vary as between the various printing scenarios.

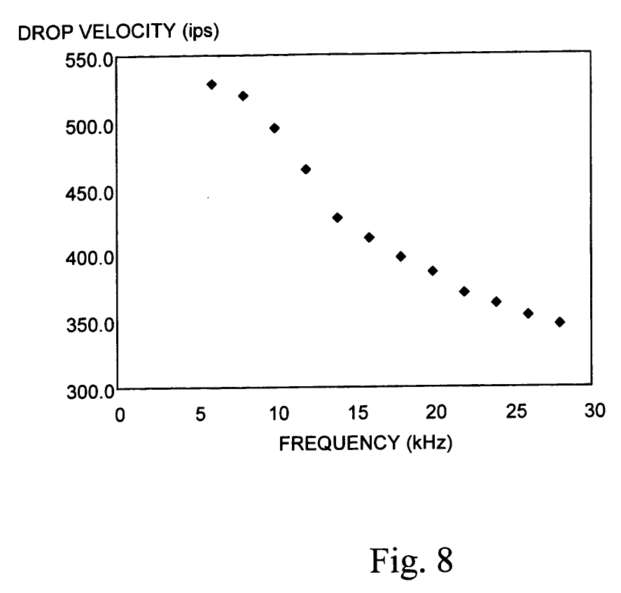

FIG. 8 illustrates this variation. FIG. 8 is a chart depicting a range of firing frequencies with respect to a range of drop velocities for printhead 34. Each data point represents an average drop velocity of all nozzles of each of nozzle arrays 92, 96 and 100 on ten color printheads of the type of printhead 34, with each nozzle having a refill time of about 25 μs. Drop velocity is related to dot position DP on the print medium sheet 30 by the following relationship.
DP=Vc*g(1/V1−1/V2)
wherein:
Vc is the carrier velocity;
g is gap between printhead 34 and the print medium sheet 30;
V1 is a minimum drop velocity; and
V2 is a maximum drop velocity.

Using the extreme velocities in this chart, V1=350 and V2=530 ips along with Vc=30 ips and g=0.047 in., the resulting dot placement error may be as large as about 35 μm, depending on the actual firing frequency used during printing.

However, rather than using a projected error, and an associated nominal compensation value, associated with a particular firing frequency, the present invention determines for each printhead, and more particularly, for each nozzle array of a printhead, a printhead specific compensation value for each of the plurality of printhead firing frequencies, which in turn may be use to compensate for printhead misalignment, particularly in the main scan direction 52, such as during bi-directional printing, based on an actual firing frequency used during printing.

At step S104 of FIG. 3, the printhead specific compensation values may be stored, for example, in printhead memory 102 associated with printhead 34, or in memory associated with imaging apparatus 14.

At step S106, a printhead specific compensation value is selected from the set of printhead specific compensation values that corresponds to a firing frequency associated with printing an image with imaging apparatus 14.

As set forth in the examples given above, each printing mode of a plurality of printing modes available in imaging apparatus 14 may have associated therewith a particular firing frequency, and the printhead specific compensation value associated with that firing frequency may be selected. For example, a multi-pass printing mode may have an actual firing frequency that is lower than a maximum firing frequency of printhead 34 when printing in a high speed mode, e.g., during draft printing or a normal single pass mode. As a more specific example, assume that a normal single pass mode has a firing frequency of 24 kHz, but a 16 pass photo mode has a firing frequency of 2 kHz. Then, for the 16 pass photo mode, the printhead specific compensation value associated with a firing frequency of 2 kHz will be selected from the set of printhead specific compensation values associated with printhead 34.

Alternatively, for example, each printing swath, such as swath 104, during the printing of an image may have associated therewith a particular firing frequency, which may be estimated and/or calculated by looking ahead at the print data that will be used to print the swath in question, and the printhead specific compensation value associated with that firing frequency will be selected. Thus, the method selects for the particular printing swath a printhead specific compensation value based on the firing frequency associated with that particular printing swath.

As a further alternative, for example, each printhead nozzle, such as ink jetting nozzles 106, may have associated therewith a particular firing frequency depending on the image data to be printed by the nozzle, which may be estimated and/or calculated, for example, by looking ahead at the print data that will be used to print a particular raster in a particular swath, and the printhead specific compensation value associated with that firing frequency for the image data may be selected for that nozzle.

While this invention has been described with respect to embodiments of the present invention, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for reducing dot placement errors in an imaging apparatus, comprising:
printing with a printhead having a plurality of nozzles a plurality of printhead alignment patterns, each printhead alignment pattern being printed at a different predefined printhead firing frequency of a plurality of printhead firing frequencies; and
determining a set of printhead specific compensation values for each of said plurality of printhead firing frequencies for use in printhead alignment.

2. The method of claim 1, further comprising storing said set of printhead specific compensation values in a printhead memory associated with said printhead.

3. The method of claim 1, further comprising storing said set of printhead specific compensation values in a memory associated with said imaging apparatus.

4. The method of claim 1, further comprising selecting a printhead specific compensation value from said set of printhead specific compensation values corresponding to a firing frequency associated with printing an image with said imaging apparatus to effect printhead alignment at said firing frequency associated with printing said image.

5. The method of claim 4, wherein said printhead specific compensation value is selected based on said firing frequency that is associated with a particular printing mode of a plurality of printing modes.

6. The method of claim 5, wherein said particular printing mode is a multi-pass printing mode having an actual firing frequency that is lower than a maximum firing frequency of said printhead.

7. The method of claim 4, further comprising:
determining a firing frequency associated with a particular printing swath; and
selecting for said particular printing swath said printhead specific compensation value based on said firing frequency associated with said particular printing swath.

8. The method of claim 4, further comprising:
determining a firing frequency associated with image data for each nozzle of said plurality of nozzles of said printhead; and
selecting for said each nozzle said printhead specific compensation value based on said firing frequency associated with said image data.

9. The method of claim 1, wherein said different predefined printhead firing frequency used in printing each of said plurality of printhead alignment patterns is achieved by changing a horizontal printing resolution for each of said plurality of printhead alignment patterns while maintaining a constant carrier velocity.

10. The method of claim 1, wherein said different predefined printhead firing frequency used in printing each of said plurality of printhead alignment patterns is achieved by changing a carrier velocity for each of said plurality of printhead alignment patterns and adjusting a firing rate of said printhead.

11. The method of claim 10, wherein each of said plurality of printhead alignment patterns is printed to create a full fill pattern.

12. The method of claim 1, wherein said different predefined printhead firing frequency used in printing each of said plurality of printhead alignment patterns is achieved by using multiple printing passes in a shingling fashion to create a full fill pattern.

13. The method of claim 1, wherein said plurality of nozzles represent a plurality of nozzle arrays, said method determining a corresponding set of printhead specific compensation values for each said nozzle array of said plurality of nozzle arrays.

14. The method of claim 13, wherein said plurality of nozzle arrays represents at least two color ink arrays.

15. The method of claim 1, wherein said set of printhead specific compensation values is associated with a particular ink color.

16. The method of claim 1, wherein said set of printhead specific compensation values is associated with a particular ink type.

17. The method of claim 16, wherein said particular ink type is one of a dye based ink and a pigment based ink.

18. A method for reducing dot placement errors in an imaging apparatus, comprising:
providing a set of printhead specific compensation values for a printhead having a plurality of nozzles, each printhead specific compensation value in said set being associated with a respective printhead firing frequency of a plurality of printhead firing frequencies; and
selecting a printhead specific compensation value from said set of printhead specific compensation values corresponding to a firing frequency associated with printing an image with said imaging apparatus to effect printhead alignment at said firing frequency associated with printing said image.

19. The method of claim 18, wherein said printhead specific compensation value is selected based on said firing frequency that is associated with a particular printing mode of a plurality of printing modes.

20. The method of claim 19, wherein said particular printing mode is a multi-pass printing mode having an actual firing frequency that is lower than a maximum firing frequency of said printhead.

21. The method of claim 18, further comprising:
determining a firing frequency associated with a particular printing swath; and
selecting for said particular printing swath said printhead specific compensation value based on said firing frequency associated with said particular printing swath.

22. The method of claim 18, further comprising:
determining a firing frequency associated with image data for each nozzle of said plurality of nozzles of said printhead; and
selecting for said each nozzle said printhead specific compensation value based on said firing frequency associated with said image data.

23. The method of claim 18, further comprising storing said set of printhead specific compensation values in a printhead memory associated with said printhead.

24. The method of claim 18, further comprising storing said set of printhead specific compensation values in a memory associated with said imaging apparatus.
